(19) United States
(12) Patent Application Publication
(10) Pub. No.: US 2008/0124130 A1
(43) Pub. Date: May 29, 2008

(54) CHARGING DEVICE, IMAGE FORMING APPARATUS AND CHARGING METHOD

(75) Inventors: Takeshi Watanabe, Kanagawa-ken (JP); Masashi Takahashi, Kanagawa-ken (JP); Mitsuaki Kouyama, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/557,552

(22) Filed: Nov. 8, 2006

(51) Int. Cl. G03G 15/02

(52) U.S. Cl. 399/176; 399/174

(57) ABSTRACT

A charging technique in which the generation of ozone is suppressed and charging efficiency can be improved is provided. There are included an elastic body to come in contact with a body to be charged, the elastic body including a portion which comes in contact with the body to be charged and is formed of a material containing a diamond particle, and a voltage application unit to charge the body to be charged by applying a specified bias voltage through the elastic body to the body to be charged.

### BACKGROUND OF THE INVENTION

1. Field of the Invention

The present invention relates to a charging technique to charge a body to be charged, and particularly to a technique to contribute to the improvement of charging efficiency.

2. Description of the Related Art

Hitherto, as a charging system or a transfer system used for an image forming apparatus such as an electrophotographic apparatus, a corona charging device is often used mainly as a non-contact charging system. In addition to this, as a contact charging system with less ozone generation, there is known roller charging, brush charging, blade charging, magnetic brush charging, proximate charging to charge a charging device, such as a roller, through a gap of several μm to several hundreds μm relative to a member to be charged, such as a photoconductor, or the like.

In the case where the roller charging or the proximate charging is used, although the amount of ozone generated from the used equipment can be reduced to a safety level, there is a problem that an electric discharge occurs at close distance from a photoconductor, high-density ozone is generated, and ion impact by an intense electric field is given to the photoconductor, and accordingly, the life of the photoconductor is remarkably shortened. This is a problem from the viewpoint of resource saving, and this is also a problem that safety is not ensured. Since such ozone is generated by an electric discharge phenomenon, in recent years, attention is paid to injection charging without electric discharge, and research and development have been vigorously performed.

The injection charging is excellent in charging efficiency, and for example, in a normal non-contact charging device, in order to charge the surface of a body to be charged to −500 v, it is necessary to apply a bias of about −800 to 1200 v to the charging device, whereas the injection charging requires only about −500 to −700 v, and is characterized in that since it does not follow the discharge law of Paschen, the generation of ozone by electric discharge is remarkably low.

Besides, as an example of charging techniques to improve charging efficiency, there is disclosed a method of forming a coating film of diamond-like carbon on the surface of a proximate charging device by a CVD method or an evaporation method (for example, see JP-A-2002-351195). It is said that since a diamond fine particle has a negative electron affinity, the charging efficiency is improved, however, in an example disclosed therein, it is necessary that for the proximate charging, the surface of the diamond-like carbon is uniformly opposite to a photoconductor, and it is inevitable to use a high cost production technique such as a CVD method, and further, since the proximate charging is used, the ratio of the electric discharge becomes large, and ozone is also generated albeit only slightly.

### SUMMARY OF THE INVENTION

It is an object of embodiments of the present invention to provide a charging technique in which the generation of ozone is suppressed and charging efficiency can be improved.

In order to solve the problem, according to an aspect of the invention, a charging device includes an elastic body configured to come in contact with a body to be charged, the elastic body including a portion which comes in contact with the body to be charged and is formed of a material containing a diamond particle, and a voltage application unit configured to charge the body to be charged by applying a specified bias voltage through the elastic body to the body to be charged.

Besides, according to another aspect of the invention, a charging device includes contact means for coming in contact with a body to be charged, the contact means including a portion which comes in contact with the body to be charged and is formed of a material containing a diamond particle, and voltage application means for charging the body to be charged by applying a specified bias voltage through the contact means to the body to be charged.

Besides, according to another aspect of the invention, a charging method includes bringing an elastic body, a portion of which comes in contact with a body to be charged and is formed of a material containing a diamond particle, into contact with the body to be charged, and charging the body to be charged by applying a specified bias voltage through the elastic body to the body to be charged.

### DESCRIPTION OF THE DRAWINGS

FIG. 1 is a schematic structural view for explaining a charging device 1 according to an embodiment and an image forming apparatus M including the same.

FIG. 2 is a view showing a detailed structure of the charging device 1 according to the embodiment.

FIG. 3 is a view showing another structural example of the charging device 1 according to the embodiment.

FIG. 4 is a view showing another structural example of the charging device 1 according to the embodiment.

FIG. 5 is a view showing another structural example of the charging device 1 according to the embodiment.

FIG. 6 is a data table showing results of a comparative experiment performed using samples for comparison.

FIG. 7 is a data table showing results of a comparative experiment performed using samples for comparison.

FIG. 8 is a view showing an image forming apparatus having a process structure different from FIG. 1.

FIG. 9 is a data table showing results of an experiment using the image forming apparatus having the process structure as shown in FIG. 8.

### DESCRIPTION OF THE EMBODIMENTS

Hereinafter, embodiments of the invention will be described with reference to the drawings.

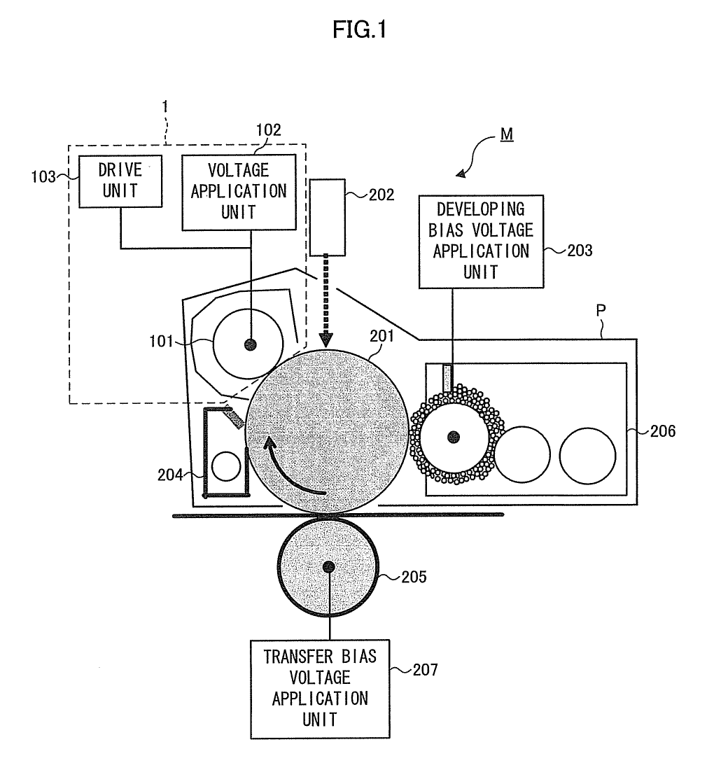

FIG. 1 is a schematic structural view for explaining a charging device 1 according to an embodiment and an image forming apparatus M (MFP: Multi Function Peripheral) including the same.

The image forming apparatus M according to the embodiment includes the charging device 1 to charge a photoconductor 201 as a body to be charged, the photoconductor 201 having a role as the body to be charged that is charged by the charging device and bears an electrostatic latent image to be developed by a developer, an exposure unit 202 to form the electrostatic latent image by exposing a photoconductive surface of the photoconductor 201, a developing unit 206 to develop the electrostatic latent image formed on the photoconductor 201 by the developer, a developing bias voltage application unit 203 to apply a specified bias voltage between the developing unit 206 and the photoconductor 201, a cleaning unit 204 to clean the developer or the like remaining on the photoconductive surface of the photoconductor 201, a transfer unit 205 to transfer a developer image to a sheet by pressing the sheet to the photoconductive surface on which the developer image is formed, and a transfer bias voltage application unit 207 to apply a specified transfer bias voltage between the transfer unit 205 and the photoconductor 201.

A process unit P integrally supports the photoconductor and at least one of the charging device, the developing unit, the cleaning unit and a memory removal member, and is detachable to and attachable from the main body of the image forming apparatus M. In this embodiment, as shown in FIG. 1, the process unit P includes an elastic body 101, the photoconductor 201, the developing unit 206, and the cleaning unit 204.

Next, the details of the charging device 1 according to this embodiment will be described. The charging device 1 of this embodiment includes the elastic body (contact means) 101, a voltage application unit (voltage application means) 102, and a drive unit (drive means) 103.

The elastic body 101 is an elastic body coming in contact with the photoconductor 201, and a portion of the elastic body 101 coming in contact with the photoconductor 201 is formed of a material containing a diamond particle.

The voltage application unit 102 applies a specified bias voltage to the photoconductor 201 through the elastic body 101, so that the photoconductive surface of the photoconductor 201 is negatively charged.

The drive unit 103 drives the elastic body so that the portion of the elastic body 101 coming in contact with the photoconductor 201 is moved relatively to the photoconductor 201.

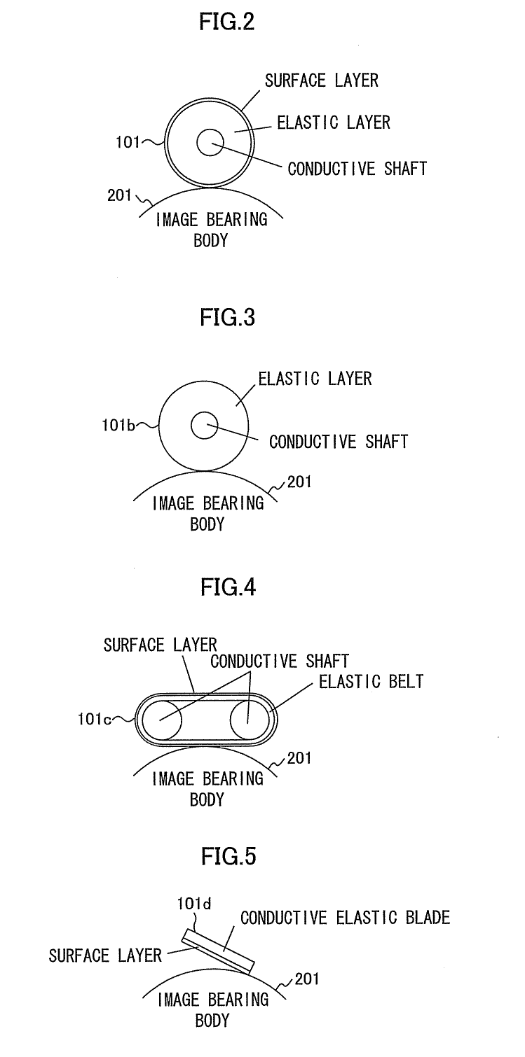

FIG. 2 is a view showing a detailed structure of the charging device 1 according to the embodiment.

The elastic body 101 of the charging device 1 of the embodiment is a charging roller, includes a conductive shaft and an elastic layer made of an elastic body of conductive urethane or the like, and further includes, as a surface layer, a layer in which a diamond fine particle is dispersed in resin or elastomer.

For example, the elastic body (contact means) 101 is a roller-shaped elastic member rotatably supported by a conductive support as shown in FIG. 2, and includes the conductive support, the elastic layer formed around the whole outer periphery thereof, and the surface layer formed on the outer periphery thereof, and the outermost layer contains the diamond fine particle (at least a part of the diamond particle is exposed on the surface).

The above is an example, and for example, the elastic body (contact means) may have a three-layer structure in which a resistance layer or the like is further provided between the elastic layer and the surface layer, or may have a more-layer structure. Besides, like an elastic body 101b shown in FIG. 3, even in a state where a surface layer is not particularly provided and an elastic layer is provided on a support body, it can be used as long as a diamond fine particle is dispersed therein. Of course, the elastic body of the embodiment is not limited to the roller shape, and for example, a belt-shaped member like an elastic body 101c shown in FIG. 4 may be adopted, or a blade shape like an elastic body 101d shown in FIG. 5 may be adopted.

Hereinafter, the details of the embodiment will be described using the elastic body 101 shown in FIG. 2 as an example.

First, as the material of the elastic layer, any material may be used as long as it is elastomer such as, for example, synthetic rubber and thermoplastic elastomer. As resin, fluorine resin, polyamide resin, acrylic resin, polyurethane resin, silicone resin, butyral resin, styrene-ethylene butylene-olefin copolymer (SEBC), olefin-ethylene butylene-olefin copolymer (CEBC) and the like are enumerated. Besides, as the elastomer, synthetic rubber and thermoplastic elastomer are enumerated. For example, as the synthetic rubber, natural rubber (vulcanizing treatment or the like), epichlorohydrin rubber, EPDM, SBR, silicone rubber, urethane rubber, IR, BR, NBR, CR and the like are enumerated. As the thermoplastic elastomer, polyolefin thermoplastic elastomer, urethane thermoplastic elastomer, polystyrene thermoplastic elastomer, fluorine rubber thermoplastic elastomer, polyester thermoplastic elastomer, polyamide thermoplastic elastomer, polybutadiene thermoplastic elastomer, ethylene-vinyl acetate thermoplastic elastomer, polyvinyl chloride thermoplastic elastomer, chlorinated polyethylene thermoplastic elastomer and the like are enumerated. These materials may be used as a single material or a mixture of two or more kinds of materials, and may be a copolymer.

Besides, a foamed body obtained by foaming and molding these elastic materials may be used as the elastic material. Preferably, in order to ensure a nip between the charging member and the photoconductor, it is preferable to use the synthetic rubber material as the elastic layer material.

It is preferable that the conductivity of the elastic layer is adjusted to be less than 10⁸ Ωcm by suitably adding a conducting agent, such as carbon black, conductive metal oxide, alkali metal salt or ammonium salt, into the elastic material. When the conductivity of the elastic layer is 10⁸ Ωcm or more, the charging capacity of the charging member becomes low, the performance to uniformly charge the photoconductor is lowered, and a poor image is often generated. Besides, the elasticity or hardness of the elastic layer is adjusted by adding softening oil, a plasticizer or the like and by foaming the elastic material.

Subsequently, the material of the surface layer is basically similar to that of the surface layer used for a conventional charging roller except that the diamond fine particle is dispersed, and any material may be used as long as it is resin or elastomer, and one similar to that of the elastic layer in this embodiment can be used.

Further, in the surface layer, various conductive fine particles are added, and the volume resistivity may be adjusted to a desired value. As the conductive fine particles, those as described before can be used, and two or more kinds of particles may be used. Further, for the purpose of controlling the surface conductivity and improving the reinforcing property, a fine particle of titanium oxide or the like can be used. Further, a release material may be contained in the surface layer. The resistance of the surface layer of about 10⁴ to 10¹⁴ Ωcm can be used. Hitherto, it is said that unless the resistance of the surface layer has a resistance value not lower than the elastic layer, a photoconductor leak is liable to occur, however, in this embodiment, since the charging is performed by the injection charging, and the applied voltage is remarkably lowered as compared with a conventional one, even if the resistance of the surface layer is low, the leak becomes hard to occur.

The measurement of the volume resistivity of the elastic layer and the surface layer was performed by using a resistance meter Hiresta made by Mitsubishi Petrochemical Co., Ltd. With respect to the elastic layer, the elastic layer material itself was molded into a plate with a thickness of 4 mm, and a voltage of 250 V was applied for 10 seconds to perform the measurement, and with respect to the surface layer, a prepared paint was coated on an aluminum sheet to have a thickness of about 30 μm, and the measurement was performed under the same condition as the elastic layer.

Besides, a manufacturing method of the elastic layer and the surface layer is not particularly limited, and they can be produced using a well-known method in the layer formation of a resin compound. The production of these layers may be performed by, for example, bonding or coating a sheet-shaped or tube-shaped layer previously formed to have a specified thickness, or by a conventionally known method such as electrostatic spray or dipping coating, or may be performed in conformance with that. Besides, a method may be such that after a layer is roughly formed by extrusion molding and the shape is adjusted by polishing or the like, or a method may also be such that a material is hardened and molded in a mold into a specified shape.

### MANUFACTURE EXAMPLE 1

Hereinafter, an example of a production method of the elastic body 101 according to the embodiment will be described.

Following materials:

| | | |
|---|---|---|
| epichlorohydrin rubber ternary copolymer | 100 | mass parts |
| (epichlorohydrin:ethylene oxide:allyl glycidyl | | |
| ether = 40 mol %:56 mol %:4 mol %) | | |
| light calcium carbonate | 30 | mass parts |
| aliphatic polyester plasticizer | 10 | mass parts |
| zinc stearate | 1 | mass part |
| antioxidant | 0.5 | mass part |
| zinc oxide | 5 | mass parts |
| quaternary ammonium salt | 2 | mass parts |

were kneaded for 10 minutes in a closed mixer adjusted to 50° C., and a raw material compound was prepared. With respect to 100 mass parts of epichlorohydrin rubber of the raw material rubber, 1 mass part of sulfur as a vulcanizing agent, 1 mass part of DM (dibenzothiazyl sulfide) as a vulcanizing accelerator, and 0.5 mass part of TS (tetramethylthiuram monosulfide) were added to this compound, and they were kneaded for 10 minutes by a two-roll machine cooled to 20° C. The obtained compound was molded by an extruder so as to have a roller shape with an outer diameter of 12 mm on a cored bar having a diameter of 6 mm and made of stainless, and after heating steam vulcanization was performed, a polishing treatment was performed by a wide width polishing system so that the outer diameter became 8.5 mm, and the elastic layer was obtained. The roller length was made 330 mm.

The surface layer was formed to cover the elastic layer. The surface layer was coat-shaped by a dipping method of a surface layer coating liquid described below.

As a diamond fine particle to be dispersed in the surface layer of the elastic body 101, a cluster diamond with a primary particle diameter of nominal 3 to 10 nm was used. As the diamond fine particle, for example, one made by New Metals and Chemicals Corporation, Ltd. can be used. It is appropriate that the shape is spherical. Since the diamond particle is generally manufactured by an explosion, it contains many impurities, and the particle diameter distribution becomes relatively broad. Then, a following refining process was first performed.

First, as a hot concentrated sulfuric acid process, cleaning was performed at 250 to 350° C. by a mixture solution of concentrated nitric acid and concentrated sulfuric acid for 2 hours, and subsequently, as a dilute hydrochloric acid process, a cleaning process was performed at 150° C. for 1 hour. Thereafter, cleaning was performed in a room temperature state by fluorinated acid for 1 hour, and the impurities were eliminated.

Thereafter, caprolactone denatured acryl polyol solution and methyl isobutyl ketone were mixed at a mass ratio of 10:25, and the refined diamond fine particle was ultrasonic dispersed therein for about 10 minutes to 5 hours while the condition was changed. Further, a centrifugal separator was used to perform a treatment at 3,000 to 20,000 G for 3 to 30 minutes, and a supernatant fluid was made the dispersion liquid of the diamond particle. In this state, it is preferable that the diamond particle has an average particle diameter in a range of 3 nm to 30 μm.

Further, with respect to 500 mass parts of the above solution,

hydrophobic rutile type titanium oxide (isobutyl trimethoxysilane and dimethyl silicone oil treated product, average particle diameter: 0.041 μm, volume resistivity: 10¹⁶ Ωcm) 25 mass parts

denatured dimethyl silicone oil 0.08 mass part

PMMA particle (average particle diameter: 5.1 μm) 60 mass parts

were used, a glass bottle was used as a container, and a mixture solution was prepared. Glass beads (average particle diameter: 0.8 mm) as a dispersion medium were filled therein so that a filling ratio became 80%, and were dispersed for 10 hours by using a paint shaker disperser. A mixture of respective butanone oxime block bodies 1:1 of hexamethylene diisocyanate (HDI) and isophorone diisocyanate (IPDI) was added to the dispersion solution so as to attain NCO/OH=1.0, and agitation was performed for 1 hours to prepare a dipping coating solution.

Subsequently, the surface layer coating liquid was twice coated on the surface of the elastic layer by the dipping method. The pulling speed was made 5 mm/sec. First, after the dipping coating solution was coated, drying by wind was performed at room temperature for 10 to 30 minutes, the roller was inverted, and the coating solution was similarly coated once more. Thereafter, drying by wind was performed at room temperature for 30 minutes or more, and subsequently, drying was performed in a hot wind circulation dryer at a temperature of 160° C. for 1 hour. The thickness of the surface layer after drying was 30 μm.

The surface of the charging roller formed in the manner as stated above was rotated at high speed and was polished, so that a part of the diamond particle was exposed on the surface, the thickness of the surface layer was decreased from 30 μm to 20 μm, and the final charging roller was obtained.

### COMPARATIVE EXAMPLE 1

In a comparative example 1, an elastic layer was formed by the same method as the example, and a common one was used. Besides, in a surface layer, a diamond fine particle was not used, but conductive tin oxide (trifluoro propyl trimethoxysilane treated product, average particle diameter: 0.05 μm, volume resistivity: 10³ Ωcm) was used to give the conductivity.

### MANUFACTURE EXAMPLE 2

As an example in which a surface layer is not provided, a diamond fine particle is dispersed in the elastic layer material used in the manufacture example 1, and that is treated as a charging member. That is, a diamond fine particle refined in the same way as the manufacture example 1 was added to the following material as the elastic layer material of the manufacture example 1:

| | | |
|---|---|---|
| epichlorohydrin rubber ternary copolymer | 100 | mass parts |
| (epichlorohydrin:ethylene oxide:allyl glycidyl | | |
| ether = 40 mol %:56 mol %:4 mol %) | | |
| light calcium carbonate | 30 | mass parts |
| aliphatic polyester plasticizer | 10 | mass parts |
| zinc stearate | 1 | mass part |
| antioxidant | 0.5 | mass part |
| zinc oxide | 5 | mass parts |
| quaternary ammonium salt | 2 | mass parts. |

After being refined, the diamond fine particle was dispersed in a mixture solution of pure water and alcohol to form a colloid solution, a treatment was performed by a centrifugal separator to extract a supernatant fluid, it was dried into a powder state, and 10 to 100 weight parts thereof was added to the above material to adjust the whole resistance. The above material was kneaded for 10 minutes in a closed mixer adjusted to 50° C., and a raw material compound was prepared. With respect to 100 mass parts of epichlorohydrin rubber of the raw material rubber, 1 mass part of sulfur as a vulcanizing agent, 1 mass part of DM (dibenzothiazyl sulfide) as a vulcanizing accelerator, and 0.5 mass part of TS (tetramethylthiuram monosulfide) were added to this compound, and they were kneaded for 10 minutes by a two-roll machine cooled to 20° C. The obtained compound was molded by an extruder so as to have a roller shape with an outer diameter of 12 mm on a cored bar having a diameter of 6 mm and made of stainless, and after heating steam vulcanization was performed, a polishing treatment was performed by a wide width polishing system so that the outer diameter became 8.5 mm, and the elastic layer was obtained. The roller length was made 330 mm.

### COMPARATIVE EXAMPLE 2

In a comparative example 2, as an example in which a surface layer is not provided, the elastic layer in the manufacture example 1 was used as the charging member without change.

A negatively charged organic photoconductor was used as a photoconductor.

The photoconductor has such a structure that on an aluminum drum with, for example, a diameter of 30 mm, from an aluminum base layer side in sequence, a first layer is an under coating layer, a second layer is a positive charge injection prevention layer, a third layer is a charge generation layer, and a fourth layer is a charge transport layer. Although this is a general function separation type organic photoconductor, the structure of the invention is not essentially limited, and a single layer type photoconductor of organic, ZnO, selenium, a-Si (amorphous silicon) or the like can also be used. Incidentally, the photoconductor here is an organic photoconductor including a photoconductive layer with a thickness of 25 microns or less.

In the conventional injection charging, a charge injection layer is generally provided as a fifth layer. As the charge injection layer, a layer obtained by dispersing a SnO₂ ultra-fine particle into photo-curing acryl resin can be cited as an example, and specifically, there is known a layer in which an SnO₂ particle doped with antimony to reduce resistance and having an average particle diameter of about 0.03 μm is dispersed at a ratio of 5:2 by weight ratio with respect to the resin. Actually, the volume resistance value of the charge injection layer is changed by the amount of dispersion of the conductive SnO₂, and in order to satisfy a condition in which an image flow is not caused, it is desirable that the resistance value of the charge injection layer is 1×10⁸ Ωcm to 10¹⁵ Ωcm, and as the photoconductor of the comparative example in this embodiment, the volume resistance value of the charge injection layer was made 1×10¹² Ωcm. With respect to the resistance value of the charge injection layer, the charge injection layer was applied onto an insulating sheet, and this was measured at an applied voltage of 100V by HAIRESUTA made by Mitsubishi Petrochemical Co., Ltd.

The coating solution prepared in this way was coated to have a thickness of about 3 μm by a suitable coating method such as a dipping coating method so that the charge injection layer was formed, and as a photoconductor of a comparative example,

a photoconductor A: an organic photoconductor up to the fourth layer without a charge injection layer, and

a photoconductor B: an organic photoconductor in which the foregoing charge injection layer was provided on the photoconductor A were used.

The samples as stated above were used, and a DC bias of −500 V was applied by constant voltage control to the charging roller manufactured by way of experiment. Besides, generally, in the charging roller, since an AC bias is often superimposed in order to stabilize the charging characteristics, also with respect to a case where a rectangular AC voltage of 1000 Hz and 900 Vpp (peak-to-peak voltage) was superimposed on the DC bias and was applied, a comparison was made.

Specifically, the setting condition of a bias voltage was made as follows:

a bias C: DC −500 v was applied by constant voltage control,

a bias D: a rectangular wave AC voltage of 1000 Hz and 900 Vpp was superimposed on DC −500 v and was applied, and

a bias E: DC −1100 v was applied by low voltage control.

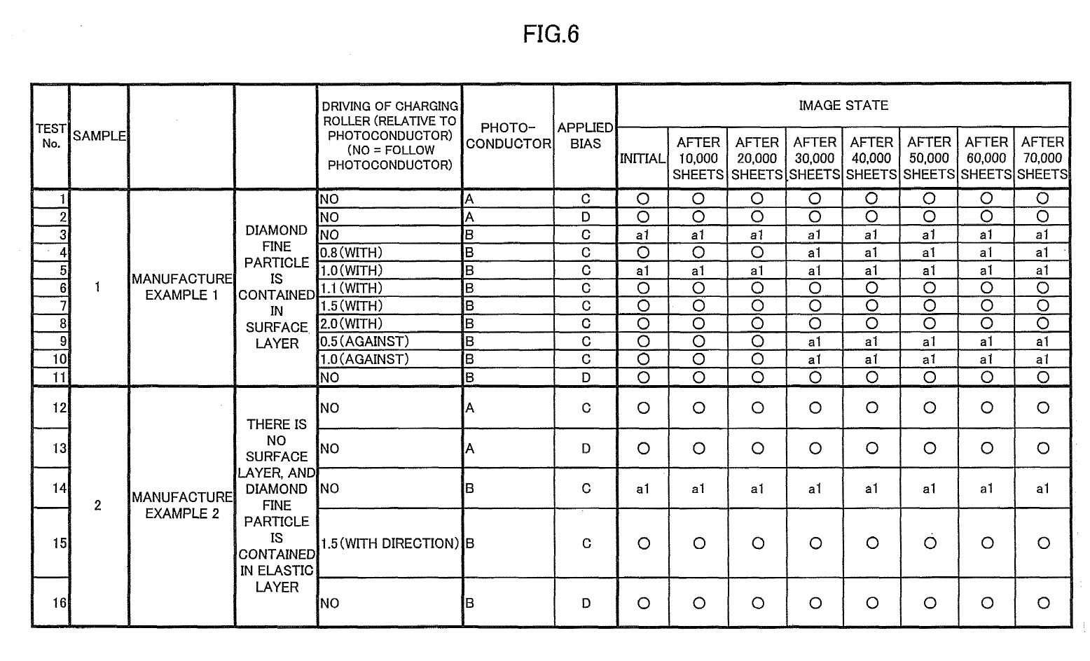

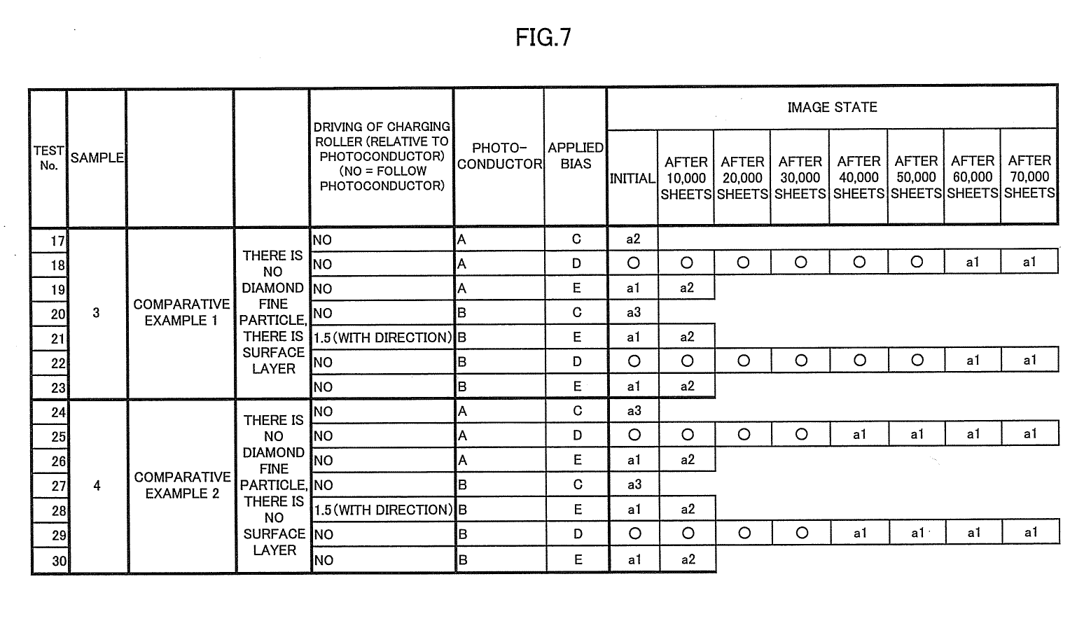

FIG. 6 and FIG. 7 show a data table showing the results of the comparative experiment performed using the samples for comparison manufactured in the manner as described above. FIG. 6 shows the former half of the data table, and FIG. 7 shows the latter half of the data table.

In the comparative experiment, a continuous printing test was performed in the image forming apparatus having the structure as shown in FIG. 1. The charging roller was made to follow the photoconductor while springs were used to apply loads of 200 g to the photoconductor from both end parts. Besides, an experiment was also performed in which the charging roller was provided with a gear and was driven, and a speed difference was given relatively to the photoconductor, and a comparison was made.

The evaluation method of an image was such that three kinds (image density: about 0.3, 0.5, 0.8) of halftone images in which the screen line number by a multi-value screen of 600 dpi was 212 lines, a whole white background image, and a whole black (solid) background image were printed on the whole surface of an A3 size sheet, and it was visually checked whether or not there occurred an image streak due to uneven charging, an image defect due to a pinhole of the photoconductor, and an attachment of the magnetic particle from the magnetic brush charging device to the photoconductor.

As a procedure, after an image is checked in the initial state of the charging device, in a state where paper is not fed, an operation in which a character chart of a printing ratio of 4% is developed on the photoconductor and collection performed by a photoconductor cleaner is performed a number of times equivalent to 10,000 sheets of A4 size paper, and then, paper is fed, and the image check as stated above is performed. With respect to a combination in which a defect did not occur on an image, the test was repeated, and the test corresponding to 70,000 sheets in total was performed.

In FIG. 6, a case where a streak due to the uneven charging occurs is denoted by “a”, and a case of an image defect due to a pinhole by generation of a leak in the photoconductor is denoted by “b”. Especially with respect to “a”, the occurrence state was visually classified into levels of 3 stages and was evaluated. Here, “level 1” is a level at which it is actually hardly noticeable, and the test was continued, however, “level 2” indicates a so-called image defect, and is the level at which the user makes a judgment of NG because of the life or the like, and the test was discontinued at that stage. Besides, “level 3” indicates a case where a halftone image itself is not normally formed, and in a case where a difference (ΔID) between the maximum value and the minimum value of reflection density on an image in which a local defect, such as a pinhole or an exposure damage, was removed was 0.4 or more, the case was made the level 3. In the table, they are respectively denoted by “a1”, “a2” and “a3”. Besides, with respect to “b”, when it occurred at a level in which it could be visually sufficiently recognized even if only slightly, a judgment of NG was made, and the test was discontinued there.

Experiment Nos. 1 to 11 are results of tests using the charging roller of the embodiment formed based on the manufacture example 1.

The test Nos. 1 and 2 show the results in which the tests were performed with the photoconductor A (with a charge injection layer), and the bias C (DC: only −500 v) and the bias D (bias of AC superposition), and excellent images could be obtained over 70,000 sheets. In the test Nos. 3 and 4, the photoconductor B (without a charge injection layer) was used, and in test No. 11 (AC superposition), an excellent result was obtained over 70,000 k, however, in test No. 3 (DC: only −500 v), slight uneven charging (streak) occurred from the beginning. However, the level was not NG, and the state could be kept over 70,000 sheets, and eventually, the test of 70,000 sheets was cleared. With respect to this result, also in the charging roller of the manufacture example 2 according to the embodiment in which the surface layer was not included, almost the same result was obtained (in experiment Nos. 12 and 13, the photoconductor with the charge injection layer was used, and in experiment No. 14, 16, the photoconductor without the injection layer was used, and in No. 14 of only DC: −500 v bias, although slight unevenness occurred from the beginning, the level was allowable up to 70,000 sheets and the test was cleared).

On the other hand, the results of the charging roller of the comparative example 1 and the comparative example 2 are shown in experiment Nos. 17 to 30. In the experiment Nos. 17 to 19, the charging roller of the comparative example 1 is applied to the photoconductor A (with a charge injection layer), and when the bias D (AC superposition) was applied, an image was stabilized from the beginning, however, at the bias C (DC: −500 v), normal charging was not performed from the beginning, and NG occurred. When −1100 v was applied although it was only DC, as in experiment No. 19, the a1 level occurred from the beginning, and after 10,000 sheets, uneven charging was increased, and NG occurred.

This tendency is the same also in the case of the photoconductor B (without a charge injection layer), and when the AC bias was applied, since, so to speak, the performance of the conventional charging roller was obtained, stable charging was possible (experiment No. 22), however, only the DC −500 v was applied, excellent charging could not be performed, and NG occurred from the beginning (experiment No. 20). Besides, also at DC: −1100 v, the same result (No. 23) as the photoconductor A was obtained. Besides, the comparative example 2 in which the surface layer was not provided on the charging roller indicated almost the same tendency as the comparative example with the surface layer.

That is, in both the comparative example 1 and the comparative example 2, when the AC bias is not superimposed, the stable charging can not be performed. Further, even if the AC bias was used, slight uneven charging occurred after 60,000 sheets. It appears that this is an ozone blur, and it appears that this occurred since the AC was superimposed, and charging was performed by a conventional electric discharge in the close region. Besides, at only the DC bias, −1100 v was applied, and when charging was performed by the electric discharge of Paschen's law, although rather uniform charging could be performed at the beginning, uneven charging became remarkable after 10,000 sheets, and both became NG.

On the other hand, as in this embodiment, in the case where the diamond fine particle is dispersed in the portion of the charging roller coming in contact with the photoconductor, when the AC bias is applied, excellent charging characteristics can be kept up to 70,000 sheets even when any type of photoconductor is used. Besides, also in the state where only DC −500 v is used and a specific photoconductor is not used, although slight uneven charging occurs, nearly excellent uniform charging is possible, that is, the injection charging not obeying the Paschen's law can be excellently performed.

Further, the uneven charging can be improved by providing a speed difference between the charging roller and the photoconductor.

Experiment Nos. 4 to 10 shows the results of experiments in which the photoconductor B (without a charge injection layer) and the bias C (only DC −500 v) were combined, and the rotation speed of the charging roller was changed by the drive unit 103. The experiment No. 3 shows the case where the charging roller was made to follow the photoconductor, whereas in the case where the charging roller was driven, at the contact part between the charging roller and the photoconductor, when the direction was the with direction (same direction) and the peripheral speed ratio was 1 (experiment No. 5), a change did not occur from the time of the follower, however, at the time of the other speeds, the initial uneven charging was eliminated. Further, at the contact part between the charging roller and the photoconductor, when the charging roller was rotated in the with direction (same direction) with respect to the photoconductor at a speed 1.1 to 2.0 times faster, the uneven charging did not occur from the beginning to 70,000 sheets, and excellent picture quality could be kept. On the other hand, in the comparative example and the like, even if the speed difference was provided between the charging roller and the photoconductor, uneven charging was not especially improved, and there was no effect. It appears that this is because in the injection charging of the contact type like the embodiment, although the diamond particle is uniformly dispersed, when the probability of contact with the surface of the photoconductor is high, the stable charging is possible.

As stated above, the drive unit 103 drives the elastic body so that the portion of the elastic body coming in contact with the body to be charged moves at a higher speed than the movement speed of the charged surface of the body to be charged.

Besides, differently from the foregoing example, when the drive unit 103 drives the elastic body so that at the position where the elastic body and the body to be charged comes in contact with each other, the portion of the elastic body coming in contact with the body to be charged is moved in the opposite direction to the specified direction, the speed difference between the surface of the elastic body and the surface of the body to be charged can be easily made large, and the probability of contact of the diamond particle with the surface of the photoconductor can be further raised.

As stated above, in the charging device according to this embodiment, it has been found that as compared with a conventional one, the charging efficiency is remarkably improved. As other effects, especially in the case where a cleanerless process is used, since the photoconductor is stably polished, it is possible to expect an effect to prevent a fixing phenomenon of toner or an external additive to the surface of the photoconductor. Next, a verification experiment for this will be described.

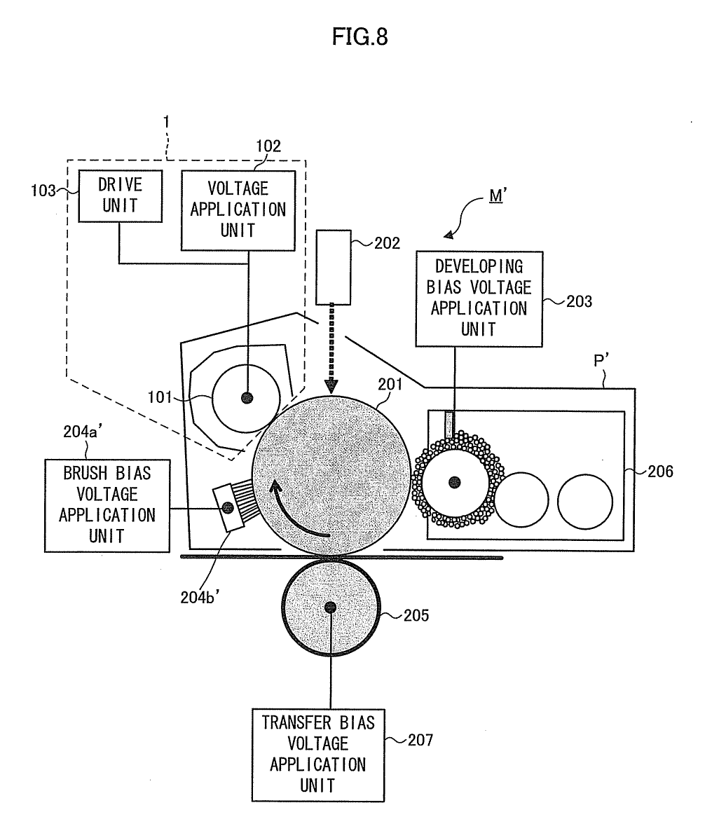

In the experiment, an image forming apparatus having a process structure as shown in FIG. 8 was used. A dedicated photoconductor cleaner is eliminated, and at that position, a fixed type brush 204b′ to which DC +600 v is applied by a brush bias voltage application unit 204a is arranged. This brush 204b′ disturbs the pattern of residual transfer toner not transferred and remaining on the photoconductor (memory removal), and is for unifying the charging polarity of the toner stably in the plus direction (memory removal member). As shown in FIG. 8, a process unit P′ includes an elastic body 101, a photoconductor 201, a developing unit 206 and the brush 204b′.

In this brush 204′, the fiber length of the brush is 4 mm, the thickness is 4 decitex, and nylon is used. The resistance is 1×10⁴ to 10⁷ Ωcm, and this is a value measured from a current value obtained when 300 v is applied in a state where the brush 204b′ is pressed to a metal plate at a load of 500 g.

In the apparatus structure as stated above, the residual transfer toner is positively charged by the brush 204b′ and is attached to the charging roller. Here, since the charging roller of the embodiment is excellent in injection charging characteristics, the toner is quickly negatively charged in a short time and is discharged onto the photoconductor. At the developing unit, the discharged toner in a non-image part is collected into the developing machine, and an image part remains on the photoconductor as a development image. In a conventional charging roller, since the residual transfer toner can not be quickly negatively charged, the charging roller is polluted, and the charging performance is lowered, however, such does not occur in the charging roller of this embodiment.

Besides, in the cleanerless process, since there is no dedicated cleaner blade and there is no member to shave the photoconductor, as stated above, the so-called photoconductor filming is liable to occur in which a toner or separated external additive is fixed to the photoconductor. However, in the charging roller of the embodiment, since the diamond fine particle stably polishes the surface of the photoconductor, the filming becomes hard to occur.

Although an evaluation in a comparative experiment was performed in the same method as the former test, the test was performed without using paper in the case where a dedicate cleaner is provided, whereas, since a dedicated cleaner was not provided in this case, paper was used and the paper feed test was actually performed.

With respect to evaluation items, in addition to “a” and “b”, “d” of an image defect due to the filming was added. This is such that a halftone, a white background, or a solid image similar to that of the former test was printed, and when a streak or a white point was generated, the surface of the photoconductor was visually checked, and a case where an attachment was recognized at a position corresponding to the image was made the filming “d”. Also in this case, a level which is allowable although a streak or a white point is recognized is made “d1”, and an NG level is made “d2”.

Besides, the amount of film shaving of the photoconductor was also measured. The amount of film shaving was measured by an eddy current type film thickness meter made by KETTO DENSHI. Measurement was performed 30 times while an arbitrary position was changed, an average value for 20 times from the center was made the film thickness, and the amount of shaving from the photoconductor of the initial state was measured.

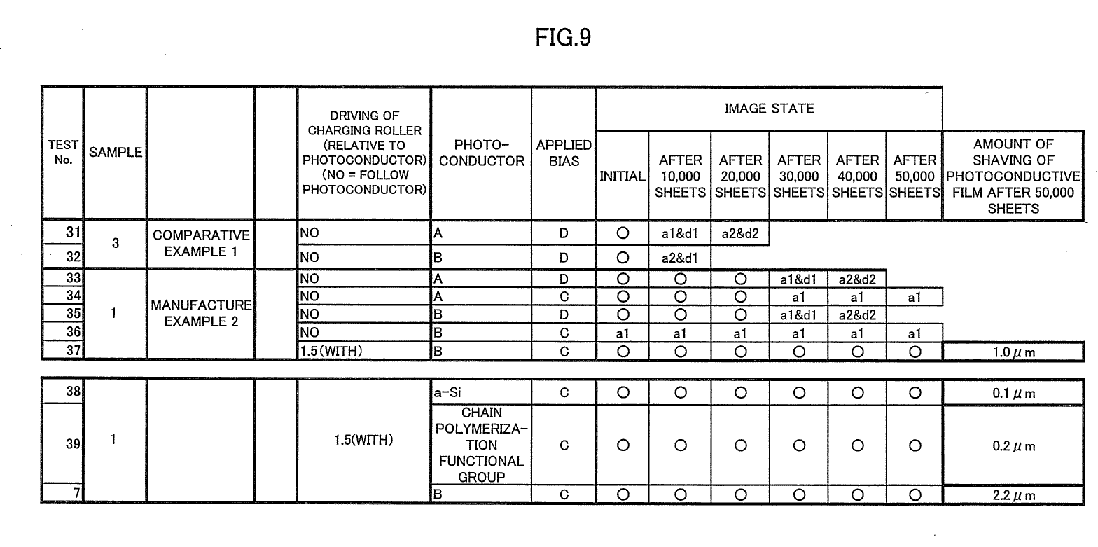

FIG. 9 is a data table showing results of experiments using the image forming apparatus having the process structure as shown in FIG. 8.

In the charging roller of the comparative example 1 of the conventional example, even in the combination of the photoconductor A (with a charge injection layer) and the bias D (AC superposition), after approximately 10,000 sheets, the “a1” level occurred due to the pollution of the charging roller, and at the same time, the filming was generated and the “d1” level occurred, and further, after 20,000 sheets, both the levels became “2” and NG occurred.

On the other hand, in the case where the charging roller of the embodiment of the manufacture example 1 was used, irrespective of the type of the photoconductor, in the combination of the bias D (AC superposition), after printing of 30,000 sheets, both uneven charging streak and filming were degraded to the level 1, and after 40,000 sheets, NG occurred. Further, in the charging roller of the manufacture example 1, also in the combination of the bias C (only DC −500 v) and the photoconductor B (without a charge injection layer), slight uneven charging occurred from the beginning, however, the filming did not occur over 50,000 sheets.

Further, like experiment No. 37, when the charging roller was driven to provide a speed with respect to the photoconductor, uneven charging disappeared and excellent picture quality could be kept over 50,000 sheets.

Also with respect to the amount of shaving of the photoconductor, in the experiment No. 37, as compared with the case where the blade cleaner is used (experiment No. 7, lowermost stage in the table), it is about half value. As stated above, by applying this embodiment, also in the case where the cleanerless process is used, the charging device is hardly polluted, and the photoconductor filming can also be prevented without significantly shaving the photoconductor, which is the original object of the cleanerless process.

The effect as stated above becomes remarkable especially in the case where a material is used so that the photoconductor surface is hardly shaven. As the photoconductor with high durability, when an inorganic photoconductor containing a-Si as its main ingredient, or an organic photoconductor containing a hole transport material having a chain polymerization functional group is used, the photoconductor has a high surface hardness and is hardly get scratched, and elongation of the life of the photoconductor is achieved. When the photoconductor as stated above is used, and when the above charging roller is used, the photoconductor itself is hardly shaven, the fixed toner component is stably removed from the photoconductor, and the photoconductor filming can be prevented.

Test results of the case where the respective photoconductors are used are shown in experiment Nos. 38 and 39 of FIG. 9. Since the charge injection layer was not provided in this test condition, since a speed was provided between the charging roller and the photoconductor, stable injection charging was possible, and a test of 50,000 sheets was cleared in a state where the photoconductor was hardly shaven.

As stated above, according to the embodiment, the charging device which can perform the injection charging is achieved at low cost and by the contact charging system in which the generation of ozone can be almost eliminated. In this embodiment, the diamond fine particle is dispersed in the outermost layer of the elastic contact charging member such as the charging roller or the blade, and by this, the charging member as stated above can be obtained.

Besides, since a normal contact charging device is in contact with the surface of a body to be charged, there has been a problem that a toner or the like charged in an opposite polarity to a bias applied to a charging member is taken into the charging device side, it becomes dirt and the performance of the charging device is lowered. Also with respect to this, in the charging device of the embodiment, since the charging efficiency is remarkably improved, the taken toner or the like can be quickly returned to the normal polarity by the injection charging, the pollution of the contact charging member can be prevented by that, and the life of the charging device itself can be elongated.

Besides, especially in recent years, from requests for the miniaturization of a device and the reduction of discharged toner, a device of a cleanerless process is increased in which a dedicated cleaning blade is not provided for a photoconductor, and a transfer residual toner is collected by a developing unit and is reused. In the case of the cleanerless process as stated above, since the amount of residual transfer toner taken into the charging device is remarkably increased, the above effect becomes further important. Besides, according to this embodiment, since the diamond fine particle comes in contact with the photoconductor, the polishing effect of the surface of the photoconductor is also obtained. Especially, in the case of the above cleanerless process, although the photoconductor is not shaven by the blade cleaner, the so-called filming phenomenon occurs in which wax in the developer or a separated external additive is attached and fixed to the surface of the photoconductor, and a defect such as a streak occurs on the image, and in many cases, when the cleaner blade is not provided, the life of the photoconductor becomes short. In such a case, according to the charging device of this embodiment, since the diamond fine particle polishes the surface of the photoconductor and gradually shaves the fixed filming, the filming of the photoconductor can also be prevented.

When the contact charging device according to this embodiment is used, the stable charging of the photoconductor becomes possible by a low applied voltage. Especially, even if a surface layer with a low resistance for injection charging is not provided at the photoconductor side, the stable charging becomes possible, and the device can contribute to the improvement of picture quality. In addition, the reversely charged toner or the like mixed in the charging device can be quickly discharged, and the durability as the charging device is also improved. Besides, by the polishing action to the surface of the photoconductor, it is possible to prevent the filming phenomenon in which the wax component in the toner or the separated external additive is fixed to the surface of the photoconductor, and it is especially effective when used for the cleanerless process. Besides, it is known that in general, when the thickness of a photoconductive layer of an image bearing body is made thin, the charging performance is lowered, however, the resolution is improved. According to the charging device of the embodiment, even in the thin photoconductive layer with the low charging performance, it can be efficiently charged, and it can contribute to the improvement of resolution in an image forming apparatus.

As in the embodiment, when a particle having a high negative electronegativity like the diamond particle is contained in the material of the contact portion of the elastic body to the body to be charged, charge injection to the body to be charged by the bias voltage applied by the voltage application part is liable to occur, and there is obtained an effect that the body to be charged can be efficiently negatively charged.

Besides, for example, by adopting the diamond particle having a hardness (hardness of a specified value or more) higher than the hardness of an attachment formed by the filming on the surface of the image bearing body, when the elastic body in the charging device is brought into contact with the surface of the image bearing body and charging is performed, the attachment due to the filming can be effectively removed. Besides, by using a particle having a rather high hardness, the deterioration of charging performance due to the abrasion of the particle can be suppressed.

Although the invention has been described in detail using the specific embodiments, it would be apparent for one of ordinary skill in the art that various modifications and improvements can be made without departing from the sprit and scope of the invention.

As described above in detail, according to the invention, it is possible to provide the charging technique in which the generation of ozone is suppressed, and the charging efficiency can be improved.

What is claimed is:

1. A charging device comprising:
an elastic body configured to come in contact with a body to be charged, the elastic body including a portion which comes in contact with the body to be charged and is formed of a material containing a diamond particle; and
a voltage application unit configured to charge the body to be charged by applying a specified bias voltage through the elastic body to the body to be charged.

2. The charging device according to claim 1, wherein the diamond particle has an average particle diameter in a range of 3 nm to 30 μm.

3. The charging device according to claim 1, wherein the elastic body is a roller-shaped elastic member rotatably supported.

4. The charging device according to claim 1, further comprising a drive unit configured to drive the elastic body so that the portion of the elastic body coming in contact with the body to be charged is moved relatively to the body to be charged.

5. The charging device according to claim 4, wherein
the body to be charged is driven so that a portion of the body to be charged coming in contact with the elastic body is moved in a specified direction, and
the drive unit drives the elastic body so that the portion of the elastic body coming in contact with the body to be charged is moved in the same direction as the specified direction at a position where the elastic body and the body to be charged come in contact with each other.

6. The charging device according to claim 5, wherein the drive unit drives the elastic body so that the portion of the elastic body coming in contact with the body to be charged is moved at a speed higher than a movement speed of a charged surface of the body to be charged.

7. An image forming apparatus comprising:
a charging device according to claim 1; and
a photoconductor, as a body to be charged, to bear an electrostatic latent image to be developed by a developer.

8. The image forming apparatus according to claim 7, wherein the photoconductor is an organic photoconductor including a photoconductive layer with a thickness of 25 microns or less.

9. The image forming apparatus according to claim 8, wherein the photoconductor includes a hole transport material having a chain polymerization functional group.

10. The image forming apparatus according to claim 8, wherein the photoconductor is an a-Si photoconductor.

11. The image forming apparatus according to claim 7, wherein the elastic body and the photoconductor are integrally supported as a process unit, and are attachable to and detachable from the image forming apparatus.

12. The image forming apparatus according to claim 7, further comprising a developing unit configured to supply the developer to the electrostatic latent image formed on the photoconductor and to collect a developer remaining on the photoconductor.

13. A charging device comprising:
contact means for coming in contact with a body to be charged, the contact means including a portion which comes in contact with the body to be charged and is formed of a material containing a diamond particle; and
voltage application means for charging the body to be charged by applying a specified bias voltage through the contact means to the body to be charged.

14. The charging device according to claim 13, wherein the diamond particle has an average particle diameter in a range of 3 nm to 30 μm.

15. The charging device according to claim 13, wherein the contact means is a roller-shaped elastic member rotatably supported.

16. The charging device according to claim 13, further comprising drive means for driving the contact means so that the portion of the contact means coming in contact with the body to be charged is moved relatively to the body to be charged.

17. The charging device according to claim 16, wherein
the body to be charged is driven so that a portion of the body to be charged coming in contact with the contact means is moved in a specified direction, and
the drive means drives the contact means so that the portion of the contact means coming in contact with the body to be charged is moved in the same direction as the specified direction at a position where the contact means and the body to be charged come in contact with each other.

18. The charging device according to claim 17, wherein the drive means drives the contact means so that the portion of the contact means coming in contact with the body to be charged is moved at a speed higher than a movement speed of a charged surface of the body to be charged.

19. A charging method comprising:
bringing an elastic body, a portion of which comes in contact with a body to be charged and is formed of a material containing a diamond particle, into contact with the body to be charged; and
charging the body to be charged by applying a specified bias voltage through the elastic body to the body to be charged.
